(19) United States
(12) Patent Application Publication
(10) Pub. No.: US 2024/0291262 A1
(43) Pub. Date: Aug. 29, 2024

(54) Overvoltage Protection Circuitry for an Electrical Device

(71) Applicant: Pilz GmbH & Co. KG, Ostfildern (DE)

(72) Inventors: Marius Fabian Oerder, Ostfildern (DE); Benedikt Karl Neumann, Ostfildern (DE)

(21) Appl. No.: 18/588,805

(22) Filed: Feb. 27, 2024

(30) Foreign Application Priority Data
Feb. 27, 2023 (DE) 102023104757.4

(51) Int. Cl. H02H 3/05; H02H 1/00; H02H 3/20

(52) U.S. Cl. CPC H02H 3/05; H02H 1/0007; H02H 3/20

(57) ABSTRACT

An overvoltage protection circuit for an electrical device includes a switch-off circuit with a detection circuit and with a first breaker circuit. The detection circuit detects a voltage that is greater than a first defined threshold value on a current path to the electrical device as an overvoltage, and the first breaker circuit performs a first disconnection of the current path based on the overvoltage being detected by the detection circuit. The switch-off circuit further includes a second breaker circuit configured to perform a second disconnection of the current path when the current path is disconnected by the first breaker circuit.

### CROSS-REFERENCE TO RELATED APPLICATIONS

This application claims priority to German Application No. 10 2023 104 757.4 filed Feb. 27, 2023. The entire disclosure of the application referenced above is incorporated by reference.

### FIELD

The present invention relates to electronics and more particularly to overvoltage protection circuitry for an electrical device.

### BACKGROUND

An overvoltage protection circuitry can be used in a safety controller or a safety switching device. It may comprise a switch-off device with a detection circuit and with a first breaker circuit. The detection circuit can detect a voltage which is greater than a first defined threshold value on a current path to the electrical device as an overvoltage and the first breaker circuit can perform a first disconnection of the current path based on the overvoltage being detected by the detection circuit. Such an overvoltage protection circuitry is shown, for example, in DE 10 2008 051 514 A1.

Safety control systems or safety switching devices, hereinafter generally referred to as safety switching devices, have power supplies that provide defined operating voltages for the electrical components used in the safety switching device. Usually, the power supplies convert higher DC or AC voltages into one or more lower operating voltages. To protect against dangerous body currents, external power supplies are usually used in safety switching devices to limit the maximum output voltage to a value that is safe for humans, even in the event of component faults. For common safety switching devices, this maximum output voltage, which must not be exceeded, is usually 65 V, whereby the nominal voltage for the operation of safety switching devices is usually 24 V.

Safety switching devices also have internal power supply units to supply the internal electrical components. These convert a nominal voltage provided by an external power supply, for example 24 V, into the required lower operating voltages, for example 3.3 V, 5 V, 12 V or 24 V. The internal power supply units must be designed to cope with an overvoltage of up to 65 V, so that even if components within the power supply unit are defective, an applied overvoltage does not damage or destroy the components of the safety switching device. A common circuitry design of such an overvoltage protection circuitry is shown, for example, in DE 10 2008 051 514 A1.

DE 10 2008 051514 A1 shows an overvoltage monitoring circuitry in which a detection unit detects an overvoltage on a current path to a device to be supplied and thereupon activates a first interrupting means in the current path, which interrupts the current path in the event of an overvoltage. Furthermore, the circuitry has a second interrupting means which is connected in parallel to the first interrupting means and which can be controlled independently of the first interrupting means. The second interrupting means can be used to bypass the first interrupting means to test it during operation. However, the problem with this overvoltage monitoring circuitry is that the first interrupting means, which is usually designed as a transistor, protects against the overvoltage alone after disconnection. If the component fails, the overvoltage can still cause damage to the device to be supplied.

### SUMMARY

It is an object of the present invention to provide an improved overvoltage protection circuitry which reliably protects against an overvoltage even after disconnection. Furthermore, it is an object to provide an overvoltage protection circuitry which can achieve reliable protection in a cost-effective manner.

According to an aspect of the present disclosure there is provided an overvoltage protection circuitry for an electrical device, comprising: a switch-off circuitry having a detection circuit and a first breaker circuit, wherein: the detection circuit is configured to detect a voltage greater than a defined first threshold value on a current path to the electrical device as an overvoltage, the first breaker circuit is configured to perform a first disconnection of the current path based on the overvoltage being detected by the detection circuit, and the switch-off circuitry further comprises a second breaker circuit configured to perform a second disconnection of the current path in response to the current path being disconnected by the first breaker circuit.

It is therefore an idea of the present disclosure to arrange a further breaker circuit in the current path, which can cut-off the current path in addition to the first breaker circuit if the first breaker circuit interrupts the current path due to an overvoltage. If an overvoltage occurs, the current path is therefore interrupted twice and thus reliably disconnected. The second breaker circuit can operate in dependence of the first breaker circuit, i.e. the second breaker circuit may be triggered directly, automatically, and immediately when the first breaker circuit has been triggered.

The second breaker circuit can be coupled with a control terminal to a section of the current path that is disconnected by the first breaker circuit in the event of an overvoltage. The disconnection by the second circuit breaker (second disconnection) may occur spatially in a portion of the current path that is upstream of a point at which the first breaker circuit disconnects the current path, i.e., in a portion of the current path between a power supply and a disconnection to the first breaker circuit.

Since the second breaker circuit provides an additional interruption of the current path, it can be switched in dependence of the first breaker circuit and therefore does not require its own detection circuit, which checks for an overvoltage and triggers the second breaker circuit independently. This means that the second breaker circuit can be simple and inexpensive and still meet the normative requirements for safety switching devices of a high protection category. For instance, the first breaker circuit can be used to achieve a very fast disconnection, while the second breaker circuit makes the electrical device intrinsically safe by additionally disconnecting the current path. The current path may be disconnected irreversibly by the second breaker circuit.

In a further refinement, a first disconnection by the first breaker circuit may be performed according to a first operating principle and a second disconnection by the second breaker circuit may be performed according to a second operating principle, the second operating principle being different from the first operating principle.

The operating principle here refers to the way in which the first disconnection and the second disconnection is being technically realized. The first operating principle can, for example, be based on a switching element, for instance, a semiconductor switch or a relay, whose switching contacts are arranged in the current path in such a way that the current path is opened or closed by actuating the switching element. The second operating principle can in turn be based on the triggering of a fuse, as is generally known, for example, from overvoltage protection by using a so-called crowbar circuit. An electrical fuse, which is arranged in the current path, can be used for this purpose. The fuse is designed in such a way that it is basically conductive, but “triggers” when a defined current is exceeded and disconnects the current path, irreversibly. The triggering can be caused deliberately, for example by short-circuiting the current path, resulting in a high short-circuit current that triggers the fuse. Applying two different operating principles has the advantage, among other things, of diversifying the disconnection, which can increase safety. Furthermore, normative requirements of higher protection categories can be effectively fulfilled.

In a further refinement, the first breaker circuit can have a first switching element arranged in the current path. The switch element makes it easy to provide a controlled shutdown of the current path. The switching element can be a relay or a semiconductor switch such as a transistor, e.g. a MOSFET. The switching element can be controlled by a control system or directly by an electrical circuit, allowing easy coupling with a detection circuit. A semiconductor switching element also enables a very fast first disconnection of the current path.

The second breaker circuit may include a second switching element having a control terminal connected to the current path at a location between the first switching element and the electrical device. The second breaker circuit can therefore be triggered via a switching element, although the disconnection of the current path itself can be based on a different principle, as described above. The switching element can be coupled to the current path via a control terminal, e.g. a gate terminal in the case of a transistor, so that it switches when the first breaker circuit disconnects the current path and the switching element is connected to the disconnected section, i.e. the section between the location of the first disconnection and the connected electrical device. For example, the second switching element can be a normally off MOSFET with its gate terminal (G) connected to the previously described section and its source terminal (S) connected to the current path at a point upstream of where the first disconnection occurs. After the first disconnection is triggered, a voltage drop occurs between the source and gate, causing the MOSFET to turn on and cause the second disconnection of the current path. In this example, the second breaker circuit can be tied to the triggering of the first breaker circuit in a simple and effective manner.

The second breaker circuit may further comprise a first interrupter element arranged in the current path in series with the first switching element, and a capacitor. The second switching element can short-circuit the capacitor and thereby trigger the first interrupter element when actuated. The second breaker circuit can therefore interrupt the current path via an interrupter element such as a fuse. The interrupter element can be arranged in series with the first switching element of the first breaker circuit in the current path. For example, the interrupter element can be arranged in a section of the current path between a power supply and the first switching element. The interrupter element can be triggered by the second switching element short-circuiting the current path with a ground connection and generating a short-circuit current that is greater than a threshold current of the interrupter element. The energy required for this can, for example, be provided by a capacitor that can be arranged between the current path and the ground connection. If the second switching element short-circuits the current path with the ground connection, the capacitor discharges via the interrupter element and triggers it. The second breaker circuit can thereby be realized in a simple and effective manner.

The second breaker circuit may further comprise a first suppressor diode connected in parallel to the capacitor between the capacitor and the interrupter element in the current path and discharging the capacitor when the first interrupter element has been triggered. When the interrupter element triggers, the capacitor is no longer short-circuited. This can happen before the capacitor is fully discharged. In this case, the capacitor can be discharged via an appropriately dimensioned suppressor diode. The design thus further ensures that the overvoltage protection circuitry is in a safe state after being activated.

In a further refinement, the overvoltage protection circuitry can have a further switch-off circuitry. The further switch-off circuitry can have a second suppressor diode, which is connected between the current path and a ground connection, and a second interrupter element, which is arranged in the current path, wherein the second suppressor diode is dimensioned such that it triggers the second interrupter element at a voltage which is greater than a second defined threshold value. In addition to the extra current path disconnection, the overvoltage protection circuitry can thus have a further switch-off circuitry that is independent of the first switch-off circuitry. The additional switch-off circuitry is redundant to the first switch-off circuitry and can be based on a different operating principle. The additional switch-off circuitry can disconnect the current path by using an interrupter element, for instance, without the need for a switching element. The suppressor diode connected between the current path and the ground connection can be dimensioned so that it becomes conductive when an overvoltage threshold is exceeded, causing a short circuit between the current path and the ground connection, which triggers the second interrupter element in a manner similar to that described above in connection with the second breaker circuit. The first interrupter element and the second interrupter element can be identical, so that only one interrupter element is required. Thereby, synergies between the individual circuits can be exploited.

It is understood that the above-mentioned features and those to be explained below can be used not only in the combination indicated in each case, but also in other combinations or on their own, without departing from the scope of the present invention.

### BRIEF DESCRIPTION OF THE DRAWINGS

Embodiments of the invention are shown in the drawings and are explained in more detail in the following description.

FIG. 1 is a simplified schematic diagram of an embodiment of an overvoltage protection circuitry.

FIG. 2 is a schematic view of various configurations of the individual circuits of FIG. 1.

FIG. 3 is an alternative second breaker circuit that can be used in an overvoltage protection circuitry according to FIG. 1 or FIG. 2.

FIG. 4 is a specific embodiment of the alternative second breaker circuit.

FIG. 5 is a simplified schematic representation of a further embodiment of an overvoltage protection circuitry.

### DETAILED DESCRIPTION

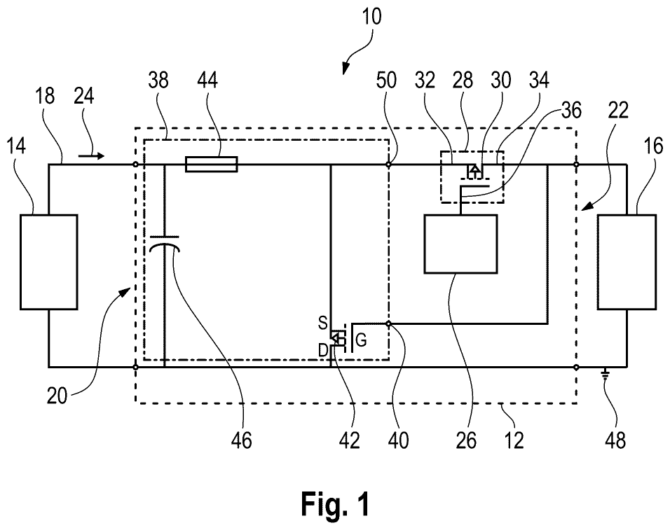

FIG. 1 shows a simplified schematic diagram of an embodiment of an overvoltage protection circuitry. In its entirety, the overvoltage protection circuitry is designated here with the reference number 10.

The overvoltage protection circuitry 10 has at least one first switch-off circuitry 12, which is arranged between a power supply 14 and a load 16. The power supply 14 can be a voltage source or a transformer. The load can be any kind of load. In the following, a power-carrying line between the power supply 14 and the load, which is essentially realized by the switch-off circuitry 12, is referred to as current path 18.

The connection of the switch-off circuitry 12 to the power supply 14 is referred to as the input side of the switch-off circuitry 12, or input 20 for short, and the connection of the switch-off circuitry 12 to the load 16 is referred to as the output side of the switch-off circuitry 12, or output 22 for short. Directional indications in relation to the current path, such as “before” and “after”, always refer to a direction 24 from the input 20 to the output 22. Elements of the switch-off circuitry 12 which are arranged before other elements, i.e. “upstream”, are thus arranged more on the input side in terms of the circuit and are therefore closer to the input 20 of the switch-off circuitry 12. Elements which are arranged after other elements, i.e. “downstream”, are elements which are arranged more closer to the output 22 of the switch-off circuitry 12 with respect to the other elements.

In the embodiment shown in FIG. 1, the switch-off circuitry 12 comprises three circuits. The first circuit is a detection circuit 26, which is configured to detect an overvoltage on the current path 18 and to provide a corresponding control signal when an overvoltage is detected. The detection circuit 26 can be a simple threshold value detection, in which a voltage on the current path 18 is continuously compared with a reference voltage (first defined threshold value). If the measured voltage exceeds the reference voltage to a defined extent, this is signaled by the detection circuit 26 by providing a corresponding output signal or, in a reverse logic, such a signal is no longer provided. Detection circuits 26 of this type are generally known in various configurations.

The second circuit of the switch-off circuitry 12 is a breaker circuit 28 (first breaker circuit). The first breaker circuit 28 is configured to disconnect the current path 18 and interrupt the power-carrying line between input 20 and output 22. In the example shown here, the first breaker circuit 28 includes a switching element 30 having switchable contacts 32, 34 that are connected to the current path 18 and having a control terminal 36 that is connected to the detection circuit 26 in such a way that a signal from the detection circuit 26, which indicates an overvoltage, leads to a switching operation by which the current path 18 is disconnected by the switching element 30. As shown here, the switching element 30 can be a self-locking (normally-off) p-channel MOSFET which is controlled by the detection circuit 26 such that it is closed in normal operation when no overvoltage is present and switches the current path 18 through.

The detection circuit 26 and the first breaker circuit 28 together form a classic overvoltage protection circuitry, which is supplemented here according to the present disclosure by a further breaker circuit 38 (second breaker circuit). The further breaker circuit 38 is the third circuit of the switch-off circuitry 12.

The second breaker circuit 38 is also configured to interrupt the current path 18. The second breaker circuit 38 can interrupt the current path 18 in addition to the first breaker circuit 28 at a position upstream of that of the first breaker circuit. In this case, the second breaker circuit 38 does not need a separate detection circuit. In fact, a triggering of the second breaker circuit 38 can be tied to a triggering of the first breaker circuit 28.

Thus, the second breaker circuit 38 can disconnect the current path 18 when the first breaker circuit 28 has disconnected the current path 18 in response to a signal from the detection circuit 26. For this link, the second breaker circuit 38 may be coupled to the current path 18 downstream of the first breaker circuit 28, i.e. at a point between the first breaker circuit 28 and the load 16 and thus in a section that is disconnected from the power supply 14 in the event of an overvoltage. For example, a control terminal 40 of the second breaker circuit 38 can be connected to the section, so that after disconnection of the current path 18 by the first breaker circuit 28 (first disconnection), the voltage present at the control terminal 40 during normal operation is no longer present at the control terminal 40.

The second breaker circuit 38 can perform the disconnection of the current path 18 (second disconnection) at a location in the current path 18 that is upstream of the first breaker circuit 28. The second disconnection of the current path 18 can thus occur before the detection circuit 26, i.e. before a point at which the detection circuit 26 determines the overvoltage on the current path 18. Accordingly, after the second disconnection, the first breaker circuit 28 and the detection circuit 26 can be isolated from the power supply.

The second breaker circuit 38 can be based on a different operating principle than the first breaker circuit 28. For example, the second breaker circuit 38 can have a switching element 42 (second switching element), an interrupter element 44 and a capacitor 46, as shown in FIG. 1. The interrupter element 44 such as a fuse can be arranged in the power-carrying line of the current path 18. The switching element 42 and the capacitor 46 can be arranged between the power-carrying line of the current path 18 and a ground terminal 48. The capacitor 46 is arranged upstream of the interrupter element 44 and the switching element 42 is arranged downstream of the interrupter element 44.

When the first breaker circuit 28 triggers and disconnects the current path 18, a voltage is applied between the control terminal 40 of the second breaker circuit 38 and an output 50 of the first breaker circuit 38, which switches the switching element 42 into a conductive state. The switching element 42 can, for example, be a self-locking (normally-off) p-channel MOSFET, which is turned on when a negative voltage is applied between the control terminal 40 (gate (G) of the MOSFET) and the output 50 (source (S) of the MOSFET), so that a current can flow between source (S) and drain (D) of the MOSFET. Turning on the switching element 42 causes the parallel-connected capacitor 46 to discharge via the interrupter element 44. Thereby, a short-circuit current flows, which triggers the interrupter element 44 and disconnects the current path 18. The current path may be disconnected irreversibly.

The second disconnection of the current path 18 by the second breaker circuit 38 thus disconnects the current path 18 in addition to the first disconnection, so that the current path 18 is disconnected twice and at different points. The disconnections can be performed in different ways. This ensures reliable and safe disconnection and can be used in power supply units for safety-critical electrical devices, e.g. safety switching devices, in order to meet the normative requirements of a high protection category.

The overvoltage protection circuitry 10 described above and those to be described below can be integrated in a power supply unit. The power supply unit can be an internal power supply unit of an electrical device, especially an internal power supply unit of a safety switching device. In this context the term “internal” means that the power supply unit is installed in a common housing with other electrical components of the electrical device. In various embodiments, the load 16 and the power supply 14 may also be arranged in this housing. The overvoltage protection circuitry 10 can be a discrete circuitry designed with discrete (wired) individual components on a printed circuit board. The circuitry can use its own circuit board or be designed together with other electrical components on a common circuit board. In addition to the overvoltage protection circuitry, the power supply unit can have other electrical components such as a transformer, for example. Furthermore, the power supply unit can have external connections for supplying power from outside, e.g. from an external power supply unit or a general power supply.

In addition to discrete electrical components, the power supply unit may have integrated circuits (IC). These can perform various functions for the provision of the desired output voltage and can also have their own overvoltage protection equipment. However, since an IC is considered as a single component in a safety-related analysis, the integrated measures such as the overvoltage protection equipment of the IC cannot normally be considered as additional protective equipment to fulfill the normative requirements.

Specific configurations of the individual circuits are explained in more detail below.

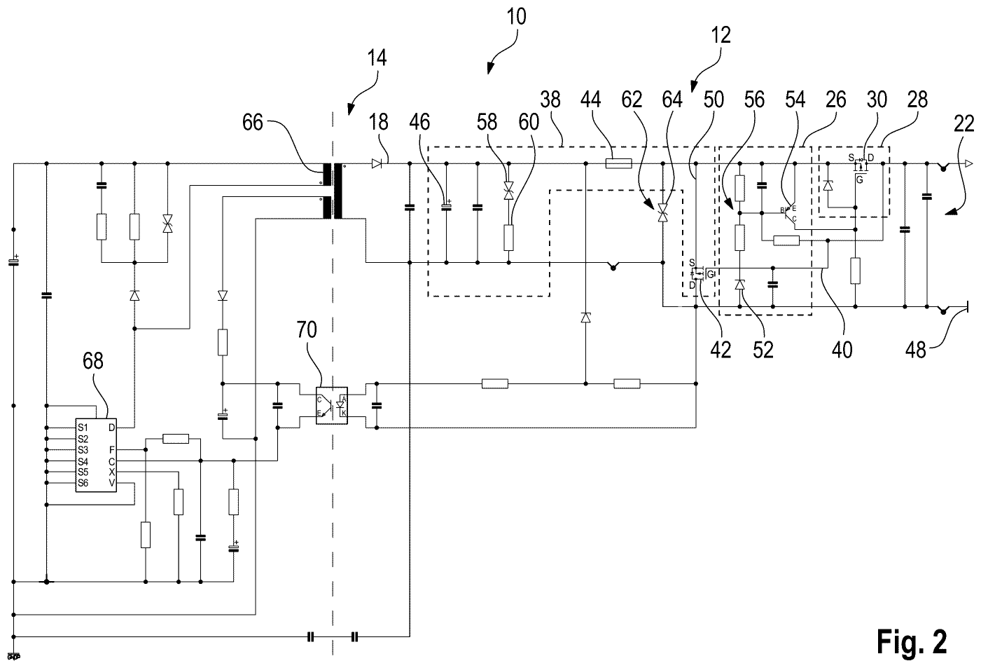

FIG. 2 shows a schematic view of configurations of individual circuits of FIG. 1. It is understood that the disclosure is not limited to the specific embodiment of FIG. 2 and that the individual circuits can be combined in other combinations or variations. In FIG. 2, the same reference signs denote the same elements as in FIG. 1. A detailed description of these elements is therefore omitted below.

The overvoltage protection circuitry 10 of the embodiment shown in FIG. 2 has a first switch-off circuitry 12 with a detection circuit 26 and with a first breaker circuit 28 and a second breaker circuit 38, as already described with reference to FIG. 1.

In the present embodiment, the detection circuit 26 includes a diode 52, a switching element 54 and a set of resistors 56. The diode 52 is connected in the blocking direction between the power-carrying line and a ground terminal 48 and, in conjunction with the resistors 56, is dimensioned in such a way that the diode 52 becomes conductive in the event of an overvoltage on the current path 18. If, for example, a voltage of 24 V is provided at the output 22 during normal operation, the diode 52 can be dimensioned in such a way that it becomes conductive at 30 V on the power-carrying line (“breakdown voltage”). The detection circuit 26 uses the switching element 54 to signal whether the diode 52 is conducting or not. The switching element 52 is connected to the first breaker circuit 28, which is formed here, as already described with reference to FIG. 1, from a switching element 30 arranged in the current path 18, e.g. a self-locking p-channel MOSFET. The switching element 52 controls the switching element 30 in such a way that in the event of an overvoltage on the current path 18, i.e. in the case of a conductive diode 52, the current path 18 is disconnected by the switching element 30 to disconnect the load (not shown here) from the power supply 14.

The switch-off circuitry 12 further comprises a second breaker circuit 38, which disconnects the current path 18 in addition to the first breaker circuit 28. In this embodiment, the second breaker circuit 38 is essentially identical to the embodiment according to FIG. 1. The second breaker circuit 38 comprises a switching element 42, an interrupter element 44 and a capacitor 46, which interact in the manner described with reference to FIG. 1 to enable a second disconnection of the current path 18 in addition to the first breaker circuit 28 and in dependence thereon.

The second breaker circuit 38 according to the embodiment shown in FIG. 2 further comprises a suppressor diode 58 and a resistor 60, which are arranged in series between the power-carrying line of the current path 18 and the ground terminal 48. If the interrupter element 44 is triggered before the capacitor 46 is completely discharged, the remaining charge can flow through the suppressor diode 58 and the resistor 60 so that the capacitor 46 is completely discharged in any case. When the capacitor 46 is discharged, there is no longer any risk of an electric shock.

The overvoltage protection circuitry 10 may further comprise a second switch-off circuitry 62. The second switch-off circuitry 62 can have a suppressor diode 64, which is connected between the power-carrying line and the ground connection 48. The suppressor diode 64 becomes conductive when a defined voltage on the current path 18 is exceeded. The suppressor diode 64 can be dimensioned so that the defined voltage corresponds to a threshold value for an overvoltage on the current path 18. The suppressor diode 64 thus becomes conductive when an overvoltage is present on the current path 18. The conductive suppressor diode short-circuits the power-carrying line of the current path 18 and the ground terminal 48. The resulting short-circuit current triggers an interrupter element in the current path 18. The interrupter element disconnects the current path 18 safely and irreversibly. The interrupter element may be a separate interrupter element of the second switch-off device 62. Alternatively, the interrupting element may be identical to the interrupting element 44 of the second breaker circuit 38. The latter makes it possible to exploit synergies between the circuits and avoid unnecessary redundancies.

The second switch-off circuitry 62 is a redundant overvoltage protection. The second switch-off device 62 may be realized using synergies with the first switch-off circuitry 12. The second switch-off circuitry 62 can be based on a different operating principle than the first switch-off circuitry 12. This effectively eliminates common cause failures. In addition, the first switch-off circuitry 12 and the second switch-off circuitry 62 can have different settings. For example, one switch-off circuitry may be dimensioned to trip as quickly as possible, while the other switch-off circuitry focuses on safe and reliable disconnection. The first switch-off circuitry 12 can, for example, effect a reversible disconnection of the current path 18 and the second switch-off circuitry an irreversible disconnection of the current path 18. It is also possible that the two circuit breakers are designed for different types of overvoltage and respond differently, for example, in terms of the level or duration of an overvoltage. In this way, an electrical device can be effectively and safely protected against a wider range of overvoltage.

In the embodiment shown in FIG. 2, the power supply 14 is a transformer and the overvoltage protection circuitry 10 is coupled with its input 20 to the secondary winding 66 of the transformer. On the primary side, there is an integrated circuit 68 for controlling the power supply unit and for regulating the power supply 14. The integrated circuit 68 can be coupled to the overvoltage protection circuitry 10 for diagnostics. For example, the integrated circuit 68 can be connected to the overvoltage protection circuitry 10 via an optoelectronic coupler 70 for galvanic isolation of the circuit parts. In principle, overvoltage protection could also be implemented via the feedback and the integrated circuit, but this would not meet the normative requirements, as the integrated circuit must be assumed to be a single component whose failure must be considered as a whole. The overvoltage protection circuitry 10 may be included in a power supply unit which is only partially shown in FIG. 2. Further components may be present on the primary side to complete the power supply 14, which have been omitted here for reasons of clarity. The further components can be inter alia external terminals for a connection to an external power supply.

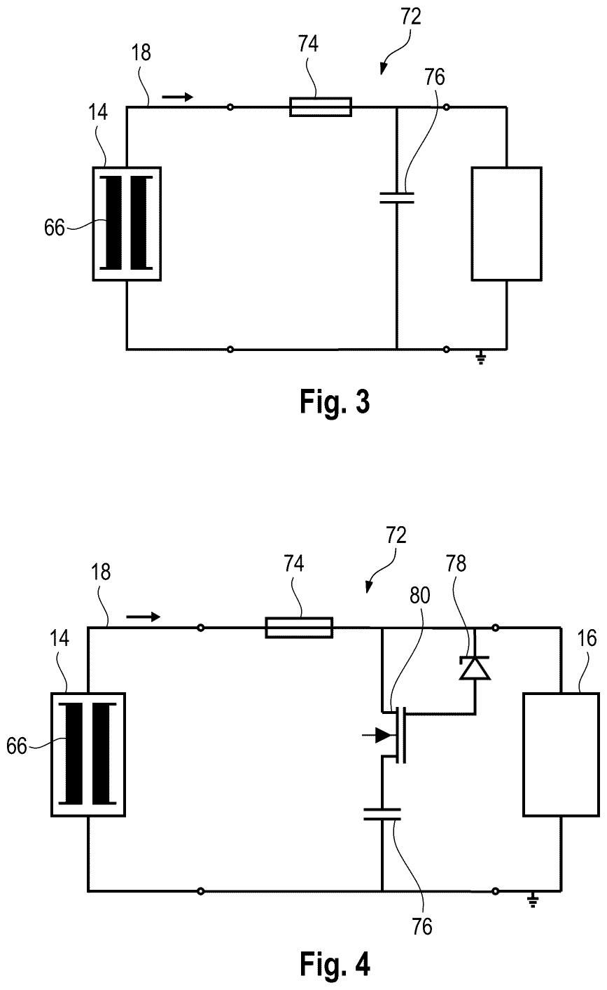

FIG. 3 shows a further second breaker circuit 72, which can be used instead of the second breaker circuit 38 in one of the overvoltage protection circuitries 10 described above. FIG. 3 illustrates the basic principle of such a circuit.

The alternative, second breaker circuit 72 has an interrupter element 74 and a capacitor 76, which interact together with a secondary winding 66 of the power supply 14 The capacitor 76 is sized such that as the voltage across the current path 18 increases and the frequency increases, the capacitor 76 and the inductance of the secondary winding 66 become a resonant oscillating circuit. The resulting increase in current triggers an interrupter element 72. The interrupter element 72 can be realized as a fuse.

The alternative, second breaker circuit 72 can thus safely disconnect the current path 18 in addition to the first breaker circuit 28 (not shown here). The current path 18 can initially be quickly disconnected by the first breaker circuit 28, while the power supply unit becomes intrinsically safe when the resonant circuit triggers the fuse.

FIG. 4 shows a specific embodiment of the alternative, second breaker circuit 72. The breaker circuit 72 according to FIG. 4 comprises a diode 78 such as a Z-diode and a switching element 80 in addition to the previously described elements of the alternative, second breaker circuit 72 according to FIG. 3.

The capacitor 76 can be connected via the switching element 80 and the diode 78 in the event of an overvoltage. This creates the previously described resonant circuit consisting of the capacitor 76 and the inductance of the secondary winding 66, if the capacitor 76 is appropriately sized. This causes an increase in current, which in turn trips the interrupter element 74 and disconnects the current path in addition to the first breaker circuit 28.

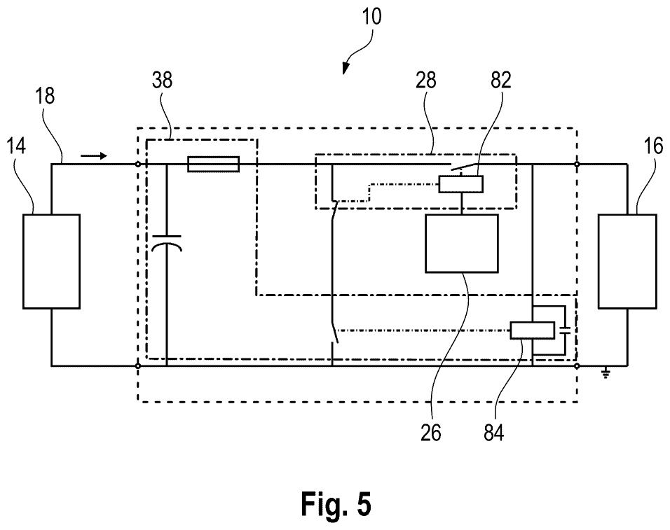

Finally, FIG. 5 shows a further embodiment of an overvoltage protection circuitry 10. The embodiment shown in FIG. 5 essentially corresponds to the embodiment shown in FIG. 1. The overvoltage protection circuitry differs only in the realization of the switching elements of the first breaker circuit 28 and the second breaker circuit 38. Instead of semiconductor switching elements, relays are used here for the switching operations of the two breaker circuits 28, 38. However, the underlying principle is the same.

At first, a first relay 82 of the first breaker circuit 28 is switched by the control of the detection circuit 26 in the event of an overvoltage so that it disconnects the current path 18. Subsequently, in response to the first disconnection of current path 18, a second relay 84 of the second breaker circuit 38 is energized to trigger an interrupter element 44 which disconnects the current path 18 at a further location upstream of the first breaker circuit 28. Thus, the current path 18 is also disconnected twice in this configuration.

The use of relay technology has the fundamental advantage that it can also be used in safety devices where the use of relay switches is required by safety standards.

Finally, it should be noted that elements of the disclosed devices and systems can be implemented using appropriate hardware and/or software elements, e.g. suitable circuits. A circuit is a structural arrangement of electronic components, including conventional circuit elements, integrated circuits, including application-specific integrated circuits, standard integrated circuits, application-specific standard products and field-programmable gate arrays. In addition, a circuit may include central processing units, graphics processing units and microprocessors that are programmed or configured according to a software code. A circuit is not pure software, even if it contains the hardware described above that executes the software.

The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

A “subset” of a first set generally includes some of the elements of the first set. In various implementations, a subset of the first set is not necessarily a proper subset: in certain circumstances, the subset may be coextensive with (equal to) the first set (in other words, the subset may include the same elements as the first set). In contexts where it is not otherwise clear, the term “proper subset” can be used to explicitly denote that a subset of the first set must exclude at least one of the elements of the first set. Further, in various implementations, the term “subset” does not necessarily exclude the empty set. As an example, consider a set of candidates that was selected based on first criteria and a subset of the set of candidates that was selected based on second criteria; if no elements of the set of candidates met the second criteria, the subset may be the empty set. In contexts where it is not otherwise clear, the term “non-empty subset” can be used to explicitly denote exclusion of the empty set.

Overall, the present invention is not limited by the examples of implementation presented here but is defined by the following claims.

1. An overvoltage protection circuit for an electrical device, the overvoltage protection circuit comprising:
a switch-off circuit having a detection circuit and a first breaker circuit, wherein:
the detection circuit is configured to detect a voltage greater than a defined first threshold value on a current path to the electrical device as an overvoltage,
the first breaker circuit is configured to perform a first disconnection of the current path based on the overvoltage being detected by the detection circuit, and
the switch-off circuit further includes a second breaker circuit configured to perform a second disconnection of the current path in response to the current path being disconnected by the first breaker circuit.

2. The overvoltage protection circuit of claim 1 wherein:
the first disconnection is performed by the first breaker circuit according to a first operating principle,
the second disconnection is performed by the second breaker circuit according to a second operating principle, and
the second operating principle is different from the first operating principle.

3. The overvoltage protection circuit of claim 1 wherein the first breaker circuit includes a first switching element arranged in the current path.

4. The overvoltage protection circuit of claim 3 wherein the second breaker circuit includes a second switching element having a control terminal coupled to the current path at a location between the first switching element and the electrical device.

5. The overvoltage protection circuit of claim 4 wherein:
the second breaker circuit further includes a first interrupter element arranged in the current path in series with the first switching element, and
the second switching element is configured to trigger the first interrupter element upon actuation.

6. The overvoltage protection circuit of claim 5 wherein:
the second breaker circuit further includes a capacitor, and
the second switching element is configured to short-circuit the capacitor upon actuation in order to trigger the first interrupter element.

7. The overvoltage protection circuit of claim 6 wherein the second breaker circuit further includes a first suppressor diode connected in parallel with the capacitor between the capacitor and the interrupter element in the current path and discharging the capacitor in response to the first interrupter element being triggered.

8. The overvoltage protection circuit of claim 1 further comprising:
a further switch-off circuit having a second suppressor diode connected between the current path and a ground terminal and having a second interrupter element arranged in the current path,
wherein the second suppressor diode is dimensioned such that it triggers the second interrupter element at a voltage greater than a second defined threshold value.

9. The overvoltage protection circuit of claim 5 wherein the first interrupter element and the second interrupter element are realized as a single component.

10. The overvoltage protection circuit of claim 1 wherein the second breaker circuit performs the second disconnection of the current path in direct dependence on the first breaker circuit.

11. The overvoltage protection circuit of claim 1 wherein:
a power supply to the overvoltage protection circuit is a transformer with an inductance to which the overvoltage protection circuit is connected,
the second breaker circuit includes a capacitor and an interrupter element, and
the capacitor is dimensioned such that in response to an overvoltage occurring, the capacitor and the inductance form a resonant circuit that results in an increase in current and trips the interrupter element.

12. The overvoltage protection circuit of claim 1 wherein the overvoltage protection circuit is integrated into a power supply unit.

13. The overvoltage protection circuit of claim 11 wherein the overvoltage protection circuit is integrated into a safety switching device.
